(19) United States
(12) Patent Application Publication
(10) Pub. No.: US 2023/0319429 A1
(43) Pub. Date: Oct. 5, 2023

(54) OBJECT DISTANCE ESTIMATION WITH CAMERA LENS FOCUS CALIBRATION

(71) Applicant: Advanced Micro Devices, Inc., Santa Clara, CA (US)

(72) Inventors: Po-Min Wang, Hsinchu (TW); Yu-Huai Chen, Hsinchu (TW); Wei-Chih Hung, Hsinchu (TW)

(21) Appl. No.: 17/710,228

(22) Filed: Mar. 31, 2022

(51) Int. Cl. H04N 5/232; G03B 13/36

(52) U.S. Cl. CPC H04N 5/232125; H04N 5/232127; G03B 13/36

(57) ABSTRACT

Systems, apparatuses, and methods for estimating object distance with camera lens focus calibration are disclosed. A relationship between in-focus lens position and object distance is captured in a calibration phase for a plurality of object distances and lens positions for a given camera. The in-focus lens positions and corresponding object distances are stored as calibration data in a memory device of the given camera. Next, during operation of the given camera, a control circuit receives the in-focus lens position that was used to capture a given image. Then, the control circuit performs a lookup of the calibration data with the in-focus lens position to retrieve a corresponding object distance. Next, the corresponding object distance is used as an estimate of a distance to an object in the scene captured in the given image by the given camera.

### BACKGROUND

### Description of the Related Art

Cameras typically include an adjustable focus mechanism to adjust the lens settings to cause an image to be in focus. One type of adjustable focus mechanism is a contrast auto-focus mechanism. Contrast is a passive technology which relies on the light field emitted by the scene. As used herein, the term “scene” is defined as a real-world environment captured in an image by a camera. In other words, the image, captured by the camera, represents the scene. A contrast auto-focus mechanism uses the image signal to determine the focus position by measuring the intensity difference between adjacent pixels of the captured image which should increase as the lens position moves closer to the focus position. As used herein, the term “lens position” refers to the position of the lens of a given camera with respect to the image sensor of the given camera. Also, as used herein, the term “in-focus lens position” refers to the optimal lens position that causes an object in a scene to be in focus in the captured image.

The auto-focus mechanism is important for a camera since blurry pictures are undesirable, regardless of other image quality characteristics. A camera is in focus when the optical rays received from the subject matter reach the sensor at the same point in the image plane. For an object at infinity, this is the case when the lens is placed at its focal length from the image sensor. For objects closer to the camera, the lens is moved further away from the image sensor.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a camera.

FIG. 2 includes a graph plotting the contrast value versus lens position for a given camera.

FIG. 3 includes a diagram of one implementation of a system for capturing calibration data for camera.

FIG. 4 is a diagram of one implementation of an apparatus including a control circuit for determining object distance.

FIG. 5 includes graphs for estimating object distance for a given in-focus lens position.

FIG. 6 is a generalized flow diagram illustrating one implementation of a method for estimating object distance with camera lens focus calibration.

FIG. 7 is a generalized flow diagram illustrating one implementation of a method for estimating object distances for multiple regions within an image.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Various systems, apparatuses, and methods for estimating object distance with camera lens focus calibration are disclosed herein. In one implementation, a relationship between in-focus lens position and object distance is captured in a calibration phase for a plurality of object distances and lens positions for a given camera. The in-focus lens positions and corresponding object distances are stored as calibration data in a memory device of the given camera. Next, during operation of the given camera capturing a given image, a control circuit uses an an in-focus lens position to perform a lookup of the calibration data so as to retrieve a corresponding object distance. The corresponding object distance is then used as an estimate of a distance to an object in the scene captured in the given image by the given camera. This estimated object distance is obtained by a single camera without the use of laser, artificial intelligence (AI) algorithms, or other costly mechanisms.

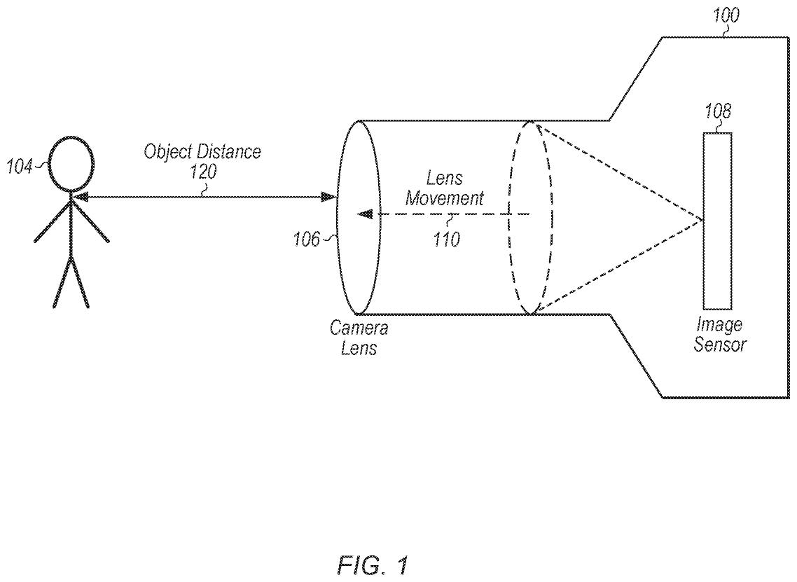

Referring now to FIG. 1, a diagram of one implementation of a camera 100 is shown. During operation of camera 100, the distance between lens 106 and image sensor 108 can be adjusted depending on the distance to an object (e.g., person 104) being captured. When first capturing an image of person 104, the camera 100 does not have knowledge of the appropriate location for lens 106 to cause person 104 to be in focus. Multiple contrast measurements can be taken for multiple positions of lens 106. The position of lens 106 that results in the highest contrast measurement is referred to as the in-focus lens position 110. During a calibration procedure, the distance 120 can be measured to the person 104. The relationship between the lens position 110 and object distance 120 can then be stored as one data point of the calibration data. During the remainder of the calibration procedure, the object can be moved to multiple different positions at known distances, and the in-focus lens position can be determined for each of these positions. The correlated values of in-focus lens position to object distance can then be stored for future use.

It is noted that any type of system or device can implement the techniques described herein, including an integrated circuit (IC), processing unit, mobile device, smartphone, tablet, computer, camera, automobile, wearable device, and other types of computing devices and systems. Additionally, any component, apparatus, or system that incorporates a camera can implement the techniques presented herein. Also, while the descriptions herein often refer to images, it should be understood that these descriptions also apply to video frames captured by a video camera or other devices capable of capturing a sequence of images.

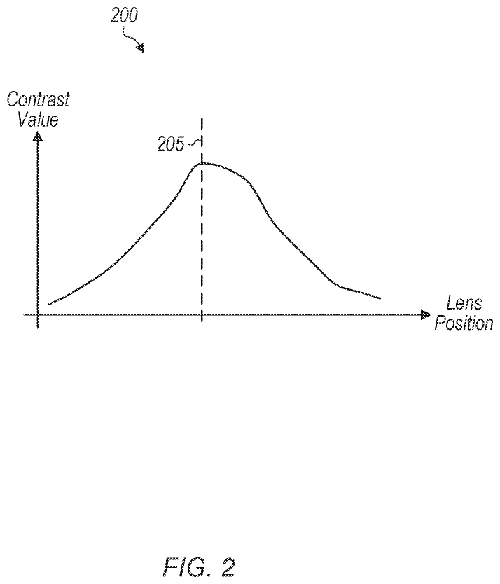

Turning now to FIG. 2, a graph 200 plotting the contrast value versus lens position for a given camera is shown. Graph 200 illustrates an example plot of contrast value versus lens position for a given camera. As used herein, the term “contrast value” refers to the intensity difference between adjacent pixels of a captured image. In one implementation, the contrast value is calculated as an average of the intensity difference of a group of pixels (e.g., a region of interest). It is noted that the terms “contrast value” and “contrast measurement” can be used interchangeably herein. The dashed vertical line 205 in the center of graph 200 represents the optimal point for capturing an in-focus image. The lens position that results in the contrast value at dashed vertical line 205 is referred to as the “in-focus lens position”. During calibration, the distance to the object that corresponds to the in-focus lens position is recorded for each object distance of multiple different known object distances. This calibration data is then used during operation to estimate the object distance for images captured by the given camera.

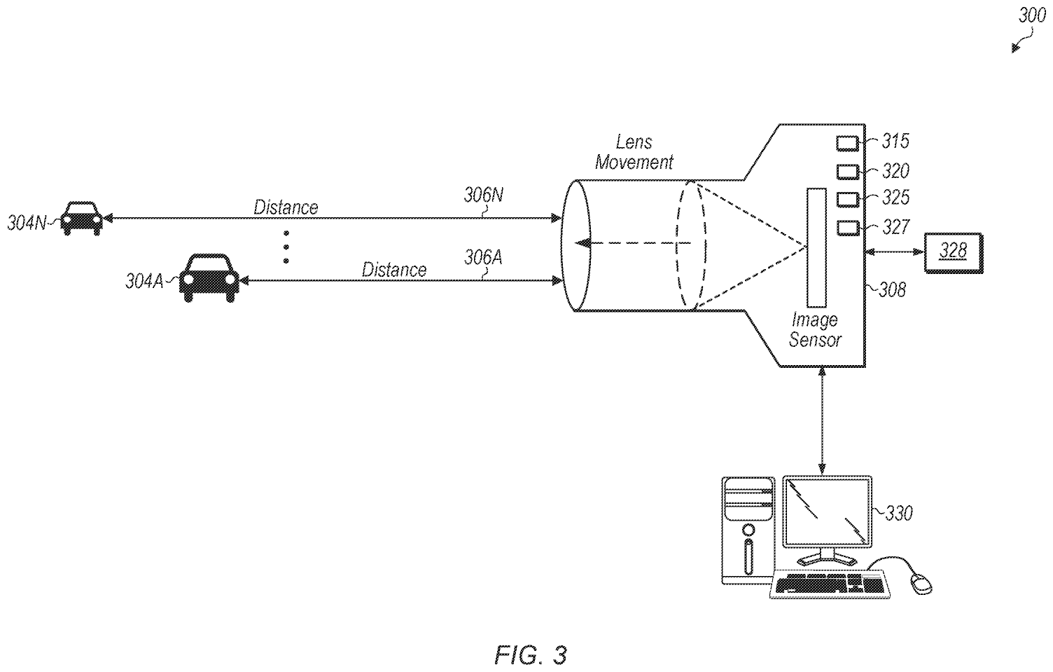

Referring now to FIG. 3, a diagram of one implementation of a system 300 for capturing calibration data for camera 308 is shown. In one implementation, an image of an object 304A a known distance 306A away from camera 308 is captured by camera 308. Object 304A is representative of any type of object being captured by camera 308. During capture of the image of object 304A, the in-focus lens position is recorded by computing system 330, and an association between the in-focus lens position and the known distance 306A is stored. Object 304A and/or camera 308 are then moved to other locations at a known distance of separation and the process is repeated any number of times. The final step of this process is represented by object 304N being captured at a known distance 306N away from camera 308. For each image capture, the correlation between known distance 306A-N and the corresponding in-focus lens position is recorded by computing system 330. In various implementations, computing system 330 can be a computer, laptop, server, mobile device, or any of various other types of computing systems or devices. In one implementation, the correlations between known distance 306A-N and the corresponding in-focus lens position for multiple distances and in-focus lens positions are stored in a table, with each entry of the table including a known distance 306A-N and the corresponding in-focus lens position. In other implementations, the correlations between known distances 306A-N and the corresponding in-focus lens positions for multiple distances and in-focus lens positions can be stored in other types of data structures.

After the calibration data is captured, the calibration data can be stored by computing system 330 in camera 308 as calibration dataset 315. Calibration dataset 315 can be stored in any type of memory device such as a non-volatile read-only memory (NVROM), electrically-erasable programmable read-only memory (EEPROM), or other type of memory device. This calibration dataset 315 can then be used during operation by camera 308 to estimate the object distance based on the in-focus lens position which results in the highest contrast value. In one implementation, the in-focus lens position is specified in terms of a converted lens position, with the converted lens position provided to control circuit 320 by a lens driver or other camera component.

For example, in the case where the converted lens position has a range of 0-to-1023, if a converted lens position of 26 corresponds to an object distance of 80 meters according to an entry in calibration dataset 315, then if a photo is captured with an in-focus lens position corresponding to a converted lens position of 26, control circuit 320 can generate an estimate that the distance to an object in the scene is 80 meters. In one implementation, control circuit 320 interpolates (e.g., using non-linear interpolation) between multiple entries of calibration dataset 315 to generate an estimate of object distance. In the above example, if calibration dataset 315 also has an entry correlating a converted lens position of 28 to 70 meters, but calibration data 315 does not have an entry for a converted lens position of 27, then control circuit 320 estimates that a converted lens position of 27 corresponds to an object distance of 75 meters based on interpolating between the two adjacent calibration dataset 315 entries for 26 and 28. However, it is noted that the relationship between converted lens position and object distance is generally not linear, and therefore a non-linear adjustment can be applied or a non-linear function can be used when interpolating between multiple entries of calibration data 315. Other techniques for interpolating so as to generate object distance estimates are possible and are contemplated. It is noted that control circuit 320 can be implemented using any suitable combination of circuitry, processing elements, and program instructions executable by the processing elements.

In one implementation, during actual, post-calibration operation of camera 308, control circuit 320 generates depth map 325 by partitioning a captured scene into a plurality of regions and determining the distances to objects in the plurality of regions. For each region, control circuit 320 determines the region's in-focus lens position which corresponds to a maximum contrast value for the region. Then, control circuit 320 performs a lookup of calibration data 315 with the region's in-focus lens position to retrieve a corresponding object distance. The object distances for the plurality of regions are then used to construct depth map 325. Next, control circuit 320 notifies depth application 327 that depth map 325 is ready, at which point depth application 327 performs one or more functions based on the object distances stored in depth map 325. Depending on the embodiment, depth application 327 can be an advanced driver-assistance application, a robotic application, a medical imaging application, a three-dimensional (3D) application, or otherwise. It is noted that depth application 327 can be implemented using any suitable combination of circuitry (e.g., application specific integrated circuit (ASIC), field programmable gate array (FPGA), processor) and program instructions. In another implementation, depth application 328 performs one or more functions based on the object distances stored in depth map 325, with depth application 328 being external to camera 308. For example, depth application 328 can be on a separate integrated circuit (IC) from camera 308, a separate peripheral device, a separate processor, or part of another component which is distinct from camera 308. Additionally, in another implementation, depth map 325 is stored outside of camera 308.

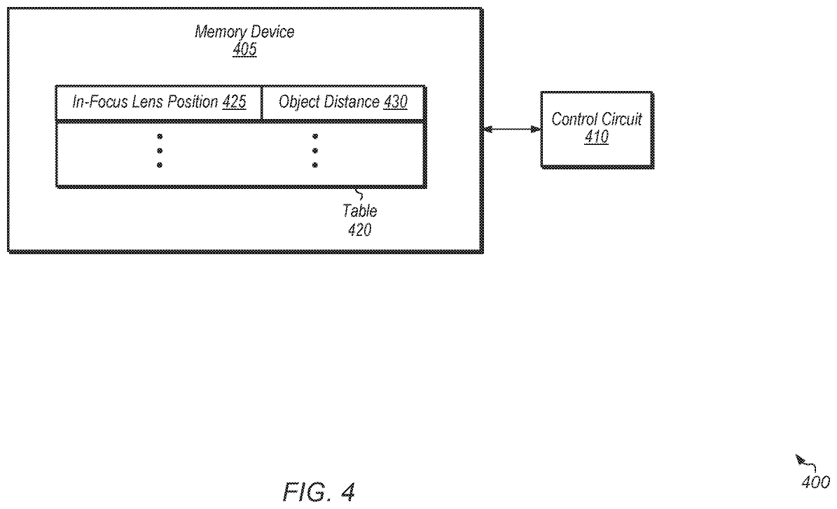

Turning now to FIG. 4, a block diagram of one implementation of an apparatus 400 including a control circuit 410 for determining object distance is shown. In one implementation, apparatus 400 includes at least control circuit 410 coupled to memory device 405. In one implementation, memory device 405 and control circuit 410 are included in a single camera (e.g., camera 308 of FIG. 3). In this implementation, only a single camera is used rather than using data from multiple cameras. Also, in this implementation, neither lasers nor artificial intelligence are used for estimating the distance to one or more objects in a scene. Rather, only a single camera is used and the single camera is able to estimate the distance to one or more objects in a scene by operating control circuit 410 in conjunction with memory device 405.

In one implementation, memory device 405 stores off-line calibration data which maps in-focus lens positions to object distances for a given camera. In one implementation, the off-line calibration data is stored in table 420 in a plurality of entries, with each entry including an in-focus lens position field 425 and object distance field 430. In this implementation, when control circuit 410 receives a request to determine the object distance for a given image being captured, control circuit 410 performs a lookup of table 420 using an actual in-focus lens position value retrieved from the camera. In one implementation, the actual in-focus lens position value is received from a lens driver. In one implementation, the actual in-focus lens position is a converted lens position with a range of 0-255, 0-512, 0-1023, 0-2047, or the like. Next, control circuit 410 identifies a matching entry for the actual in-focus lens position and then an object distance is retrieved from the matching entry. The object distance is then provided to one or more agents (e.g., processor, input/output device). If there is not an exact match for the lens distance in table 420, then control circuit 410 can interpolate between the two closest entries to calculate a predicted object distance from the object distances retrieved from the two closest entries. In one implementation, control circuit 410 uses non-linear interpolation to calculate a predicted object distance from the object distances retrieved from the two closest entries. In another implementation, control circuit 410 uses non-linear interpolation to calculate a predicted object distance from the object distances retrieved from three or more entries of table 420.

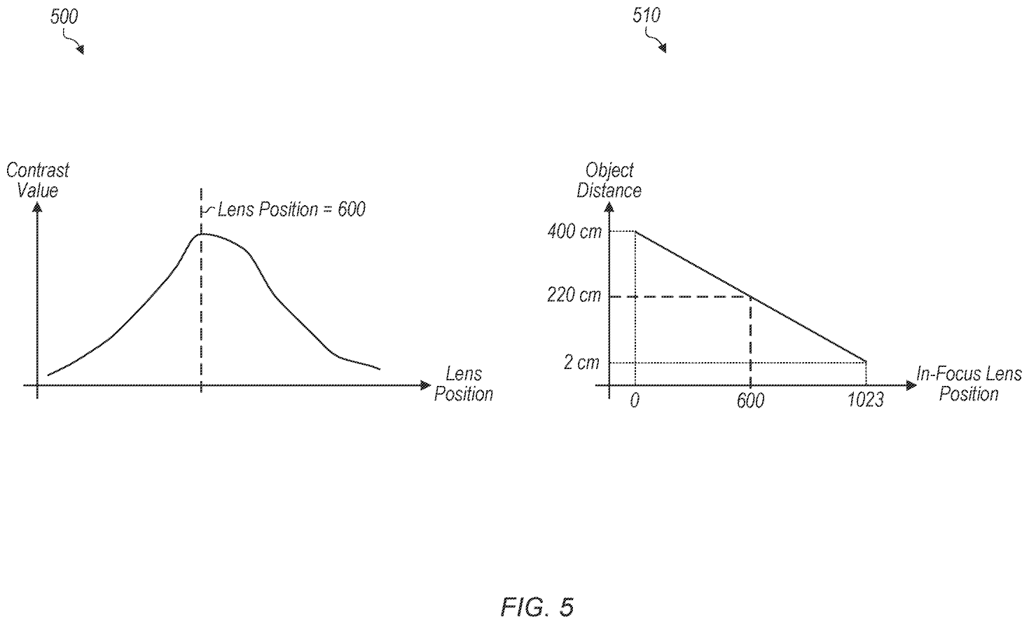

Referring now to FIG. 5, graphs 500 and 510 for estimating object distance for a given in-focus lens position are shown. On the left-side of FIG. 5, graph 500 illustrates an example contrast map which measures the contrast value for multiple lens positions for a given scene being captured by a camera. In one implementation, the maximum contrast value is identified, and then the lens position for this maximum contrast value is determined. As shown in graph 500, the in-focus lens position is 600 for the maximum contrast value for this particular example. For this example, the lens position has a range of 0 to 1023. However, it should be understood that this is representative of one particular implementation. In other implementations, the lens position can have other ranges.

In one implementation, after identifying the in-focus lens position of 600, the next step is estimating the object distance for this in-focus lens position. In one implementation, off-line calibration data is accessed to map the in-focus lens position to a corresponding object distance. Graph 510 on the right-side of FIG. 5 illustrates a mapping of in-focus lens position to object distance, with the mapping based on previously generated calibration data. As shown in graph 510, an in-focus lens position of 600 maps to an object distance of 220 cm. The distance of 220 cm can then be used as an estimate of the object distance for the particular image being captured. It is noted that the mapping of in-focus lens position to object distance shown in graph 510 is merely representative of one particular set of calibration data. Other calibration datasets can have other mappings of in-focus lens position to object distance.

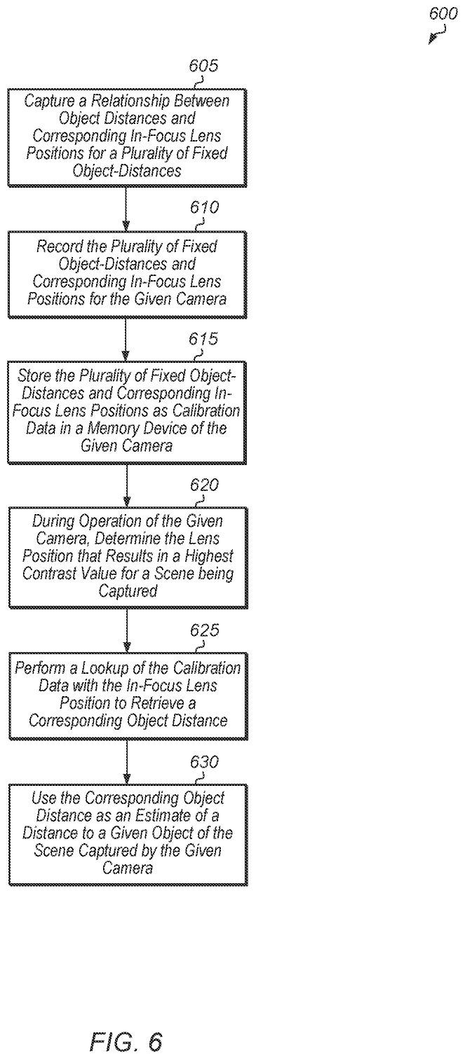

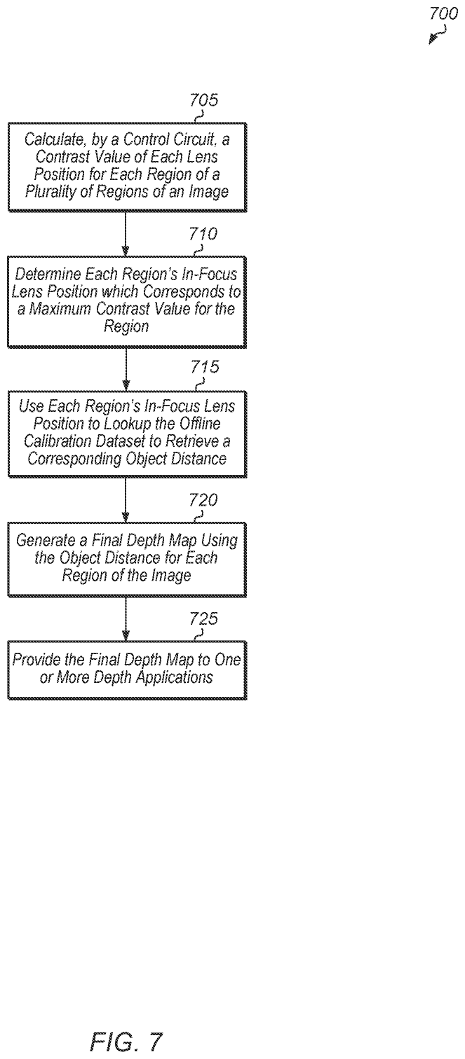

Turning now to FIG. 6, one implementation of a method 600 for estimating object distance with camera lens focus calibration is shown. For purposes of discussion, the steps in this implementation and those of FIG. 7 are shown in sequential order. However, it is noted that in various implementations of the described methods, one or more of the elements described are performed concurrently, in a different order than shown, or are omitted entirely. Other additional elements are also performed as desired. Any of the various systems or apparatuses described herein are configured to implement method 600 (and method 700).

A computing system captures a relationship between object distances and corresponding in-focus lens positions for a plurality of fixed object distances (block 605). For example, a calibration scheme can be implemented to determine an in-focus lens position for a given object at different known distances from the camera. Next, the plurality of fixed object-distances and corresponding in-focus lens positions are recorded for the given camera (block 610). Then, the plurality of fixed object-distances and corresponding in-focus lens positions are stored as calibration data in a memory device of the given camera (block 615).

Next, during operation of the given camera, the given camera determines the lens position that results in a highest contrast value for a scene being captured (block 620). It is noted that the lens position that results in a highest contrast value is referred to as the “in-focus lens position”. Next, a control circuit performs a lookup of the calibration data with the in-focus lens position to retrieve a corresponding object distance (block 625). The corresponding object distance is then used as an estimate of a distance to a given object in the scene captured by the given camera (block 630). After block 630, method 600 ends.

Referring now to FIG. 7, one implementation of a method 700 for estimating object distances for multiple regions within an image is shown. A control circuit (e.g., control circuit 320 of FIG. 3) calculates the contrast value of each lens position for each region of a plurality of regions of an image (block 705). Each region corresponds to a portion of the image. For example, in one implementation, the image is partitioned into a grid of rectangular regions. In other implementations, the image can be partitioned into other types of regions. Also, the size of each region and the number of regions per image can vary according to the implementation.

Next, the control circuit determines each region's in-focus lens position which corresponds to a maximum contrast value for the region (block 710). Then, the control circuit uses each region's in-focus lens position to lookup the offline calibration dataset to retrieve a corresponding object distance (block 715). Next, the control circuit generates a final depth map using the object distance for each region of the image (block 720). As used herein, a “depth map” is defined as a collection of information relating to the distance of scene objects in the regions of a captured image. In some applications, a “depth map” is analogous to a depth buffer or Z buffer. The resolution of the depth map can vary from implementation to implementation, depending on the number of regions in the image. Then, the final depth map is provided to one or more depth applications (e.g., Bokeh Effect application, background replacement application, machine vision application) (block 725). After block 725, method 700 ends.

For example, in one implementation, the depth map can be used for applying a Bokeh Effect to the image. In this implementation, different regions of the image can be classified as background layers or foreground layers based on the final depth map. Then, one or more image processing effects (e.g., blurring) can be applied to the background layer so as to emphasize the foreground layer. In another implementation, background replacement can be employed based on the depth map. For example, the camera can replace the background pixels of the image with something else, such as a sky, a solid color, or another effect to create the desired visual impression. In a further implementation, a machine vision application uses the depth map to identify which objects are near and which objects are far. For example, a robot can identify a near object from the final depth map, and then the robot can grab the near object with a robotic arm. In still further implementations, video conferencing applications, computer vision applications, surveillance applications, automotive applications (e.g., self-driving cars), virtual reality applications, and others can use the depth map produced by method 700. It should be understood that these are merely non-limiting examples of uses of the depth map generated by method 700.

In various implementations, program instructions of a software application are used to implement the methods and/or mechanisms described herein. For example, program instructions executable by a general or special purpose processor are contemplated. In various implementations, such program instructions are represented by a high level programming language. In other implementations, the program instructions are compiled from a high level programming language to a binary, intermediate, or other form. Alternatively, program instructions are written that describe the behavior or design of hardware. Such program instructions are represented by a high-level programming language, such as C. Alternatively, a hardware design language (HDL) such as Verilog is used. In various implementations, the program instructions are stored on any of a variety of non-transitory computer readable storage mediums. The storage medium is accessible by a computing system during use to provide the program instructions to the computing system for program execution. Generally speaking, such a computing system includes at least one or more memories and one or more processors configured to execute program instructions.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. An apparatus comprising:
a memory storing calibration data indicating a relationship between in-focus lens position and object distance for a given camera; and
a control circuit configured to:
receive an indication of a given lens position of the given camera for a captured image; and
perform a lookup of the calibration data with the given lens position to retrieve a given distance value, wherein the given distance value represents an estimated distance to a given object in the captured image.

2. The apparatus as recited in claim 1, wherein the control circuit is further configured to provide, to a depth application, the estimated distance to the given object, and wherein the given lens position is an actual in-focus lens position for the captured image.

3. The apparatus as recited in claim 1, wherein the control circuit is further configured to determine a plurality of estimated distances to a plurality of objects in different regions of the captured image.

4. The apparatus as recited in claim 3, wherein the control circuit is further configured to generate a depth map from the plurality of estimated distances to the plurality of objects in different regions of the captured image.

5. The apparatus as recited in claim 1, wherein the calibration data comprises a plurality of entries mapping a plurality of in-focus lens positions to corresponding object distances.

6. The apparatus as recited in claim 5, wherein the control circuit is further configured to:
retrieve first and second object distances from first and second entries when the given lens position is in between first and second in-focus lens positions of the first and second entries; and
interpolate between first and second distances retrieved from the first and second entries to generate the estimated distance.

7. The apparatus as recited in claim 1, wherein the control circuit is further configured to:
determine, for a given region, an in-focus lens position which corresponds to a maximum contrast value for the given region; and
perform a lookup of the calibration data with the in-focus lens position to retrieve a corresponding object distance.

8. A method comprising:
storing, in a memory, calibration data indicating a relationship between in-focus lens position and object distance for a given camera;
receiving, by a control circuit, an indication of a given lens position of the given camera for a captured image; and
performing a lookup of the calibration data with the given lens position to retrieve a given distance value, wherein the given distance value represents an estimated distance to a given object in the captured image.

9. The method as recited in claim 8, further comprising providing, to a depth application, the estimated distance to the given object, and wherein the given lens position is an actual in-focus lens position for the captured image.

10. The method as recited in claim 8, further comprising determining a plurality of estimated distances to a plurality of objects in different regions of the captured image.

11. The method as recited in claim 10, further comprising generating a depth map from the plurality of estimated distances to the plurality of objects in different regions of the captured image.

12. The method as recited in claim 8, wherein the calibration data comprises a plurality of entries mapping a plurality of in-focus lens positions to corresponding object distances.

13. The method as recited in claim 12, further comprising:
retrieving first and second object distances from first and second entries when the given lens position is in between first and second in-focus lens positions of the first and second entries; and
interpolating between first and second distances retrieved from the first and second entries to generate the estimated distance.

14. The method as recited in claim 8, further comprising to:
determining, for a given region, an in-focus lens position which corresponds to a maximum contrast value for the given region; and
performing a lookup of the calibration data with the in-focus lens position to retrieve a corresponding object distance.

15. A camera comprising:
a lens; and
a control circuit configured to:
receive an indication of a given position of the lens for a captured image; and
perform a lookup of calibration data with the given position to retrieve a given distance value, wherein the given distance value represents an estimated distance to a given object in the captured image.

16. The camera as recited in claim 15, wherein the control circuit is further configured to provide, to a depth application, the estimated distance to the given object, and wherein the given position of the lens is an actual in-focus lens position for the captured image.

17. The camera as recited in claim 15, wherein the control circuit is further configured to determine a plurality of estimated distances to a plurality of objects in different regions of the captured image.

18. The camera as recited in claim 17, wherein the control circuit is further configured to generate a depth map from the plurality of estimated distances to the plurality of objects in different regions of the captured image.

19. The camera as recited in claim 15, wherein the control circuit is further configured to:
determine, for a given region, an in-focus lens position which corresponds to a maximum contrast value for the given region; and
perform a lookup of the calibration data with the in-focus lens position to retrieve a corresponding object distance.

20. The camera as recited in claim 15, wherein the control circuit is further configured to retrieve first and second object distances from first and second entries when the given position is in between first and second positions of the first and second entries.
